(19) United States
(12) Patent Application Publication
(10) Pub. No.: US 2006/0054708 A1
(43) Pub. Date: Mar. 16, 2006

(54) Method and apparatus for controlling power of RFID module of handheld terminal

(75) Inventors: Ji-hun Koo, Yongin-si (KR); Si-gyoung Koo, Seoul (KR); Woo-shik Kang, Suwon-si (KR); Moutchkaev Artem, Yongin-si (KR); Pierre Dehaut, Yongin-si (KR); Kyung-ho Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD.

(21) Appl. No.: 11/193,430

(22) Filed: Aug. 1, 2005

(30) Foreign Application Priority Data
Sep. 13, 2004 (KR) 10-2004-0073088

(51) Int. Cl. G06K 19/06

(52) U.S. Cl. 235/492

(57) ABSTRACT

A method and apparatus for controlling a power of an RFID module of a handheld terminal are provided. The apparatus includes a power supply part that supplies power to the RFID module, an inertial sensor part that detects motion of the handheld terminal and outputs a motion detection signal, and a user intention estimating part that recognizes a motion pattern of the handheld terminal using the motion detection signal, and outputs an RFID operation intention estimating signal if it is estimated that a user intends to use the RFID module part. A control part is used to activate the power supply part when the RFID operation intention estimating signal is input into the control part.

### CROSS-REFERENCE TO RELATED APPLICATIONS

This application claims the priority from Korean Patent Application No. 10-2004-0073088, filed on Sep. 13, 2004, in the Korean Intellectual Property Office, the disclosure of which is incorporated herein in its entirety by reference.

### BACKGROUND OF THE INVENTION

1. Field of the Invention

Methods and apparatuses consistent with the present invention relate to controlling power of a radio frequency identification (RFID) module of a handheld terminal, and more particularly, to controlling power of an RFID module of a handheld terminal, in which an operation of the RFID module is controlled by using an inertial sensor to identify a motion pattern of the handheld terminal and estimating a user intention.

2. Description of the Related Art

RFID is a technology that uses radio frequency (RF) to transmit data to and/or receive data from an RFID tag attached to an object, and provides a related service. An RFID system identifies individual products using RF. In the case of a bar code, a laser reader must directly touch the bar code. However, when using an RFID tag, the information on the product can be easily identified, without directly touching the reader on the tag, and can also input necessary information. This is accomplished through the use of an RFID tag and antenna combination. Compared with the bar code, an RFID can store a large amount of information and provide long-distance information transmission and reception. Also, an RFID tag can be easily attached.

An RFID system has following advantages. First, since the RFID system has a read/write function, a variety of information can be updated. Second, since the RFID system has a transparency function, contactless and long-distance information acquisition and transmission of a nonmetal material (clay, paint, oil, tree, water, and so on) are possible. Third, the RFID system allows the RFID tag and receiver to be easily installed because they can be installed in an unnoticeable location. Fourth, there is little maintenance cost associated with RFID systems. When a reuse rate of the RFID system is high, a price of the RFID system is lower than that of the bar code. The RFID system has a high stability because its forgery or falsification is difficult. Fifth, the RFID system can acquire data about a moving object by increasing an information identification rate. Sixth, since the RFID system can acquire selective information, only desired information among a variety of RFID tag information may be collected.

Due to these advantages, the RFID system has been applied to long-distance high-speed systems such as a toll collection system, as well as short-distance low-speed systems such as a security system. In the future, it is expected that an RFID system will be used in a monetary system and can also be applied to new systems in which a telephone card, a cash card, an identification card and so on are integrated.

An RFID system includes an RFID tag for storing data, an RFID reader for reading out the data from the RFID tag, and an antenna for transferring the data between the RFID tag and the RFID reader. In the RFID system, the RFID tag receives a magnetic field from the RFID reader and the data transmission is achieved between the RFID tag and the RFID reader.

Since the RFID reader is provided separately, it is convenient to carry the RFID reader. In order to increase portability, many developments have been made to install the RFID reader and the handheld terminal positioning the same device.

However, the RFID reader that transmit data to and/or receive data from the RFID tag consumes a large amount of current, for example 50-100 mA, so as to maintain the active state. Accordingly, in cases where power saving is required, so as to reduce the power consumption, the power must be turned off when the RFID reader is not used and then must be turned on only when the RFID is to be used. A simple method for turning on/off the power is to install a power on/off switch. However, this method is inconvenient because the switch must be turned on before the RFID reader is used and must be turned off after the RFID reader is used.

Also, if the RFID reader continuously generates an electromagnetic wave, of a predetermined frequency at a constant period and the RFID tag accesses the RFID reader, the RFID tag can receive the power from the RFID reader and can become active. However, to do this, the RFID reader must continuously generate the electromagnetic wave without regard to the presence/absence of the RFID tag, resulting in power dissipation.

### SUMMARY OF THE INVENTION

The present invention provides a method and apparatus for controlling power of an RFID module of a handheld terminal, in which an operation of the RFID module of the handheld terminal is controlled by using an inertial sensor to recognize a motion pattern of the handheld terminal and estimating a user's intention.

According to an aspect of the present invention, an apparatus for controlling a power of an RFID module of a handheld terminal includes: a power supply part which supplies the power to the RFID module; an inertial sensor part which detects a motion of the handheld terminal and outputting a motion detection signal; a user intention estimating part which recognizes a motion pattern of the handheld terminal using the motion detection signal, and outputs an RFID operation intention estimating signal if it is estimated that a user intends to use the RFID module part; and a control part which activates the power supply part when the RFID operation intention estimating signal is input into the control part.

The user intention estimating part may include: a differentiator which removes a DC component from the motion detection signal; a level detector which outputs a level detection signal if an output signal of the differentiator has a level higher than a reference value; and an intention estimator which outputs the RFID operation intention estimating signal to the control part, if the level detection signal is inputted from the level detector for a predetermined duration.

The apparatus may further include a storage part which stores reference data with respect to the motion pattern of the handheld terminal, and the user intention estimating part may estimate a user intention by extracting a motion pattern data from the motion detection signal, which is inputted from the inertial sensor part, and compares the motion pattern data with the reference data, which is stored in the storage part.

The inertial sensor part may include: an inertial sensor which senses a variation in the motion of the handheld terminal; and an analog-to-digital converter which converts an output signal of the inertial sensor into a digital signal and outputs the motion detection signal.

According to another aspect of the present invention, a method for controlling a power of an RFID module of a handheld terminal includes: detecting a motion of the handheld terminal using an inertial sensor and outputting a motion detection signal; recognizing a motion pattern of the handheld terminal using the motion detection signal, estimating a user intention, and outputting an RFID operation intention estimating signal; and if the RFID operation intention estimating signal is inputted, controlling a power supply part to activate the RFID module.

According to a further another aspect of the present invention, there is provided a computer-readable recording medium storing a program which executes the method for controlling the power of the RFID module of the handheld terminal.

### BRIEF DESCRIPTION OF THE DRAWINGS

The above and other aspects of the present invention will become more apparent by describing certain exemplary embodiments thereof with reference to the attached drawings in which:

FIG. 1 is a block diagram illustrating an apparatus for controlling power of an RFID module of a handheld terminal according to an exemplary embodiment of the present invention;

FIG. 2 is a block diagram of the inertial sensor part shown in FIG. 1;

FIG. 3A is a block diagram of the user intention estimating part shown in FIG. 1 according to an exemplary embodiment of the present invention;

FIG. 3B is a block diagram of the user intention estimating part shown in FIG. 1 according to another exemplary embodiment of the present invention;

FIG. 4 is a flowchart illustrating a method for controlling a power of an RFID module of the handheld terminal according to an exemplary embodiment of the present invention; and

FIG. 5 is a flowchart illustrating a method for controlling a power of an RFID module of the handheld terminal according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

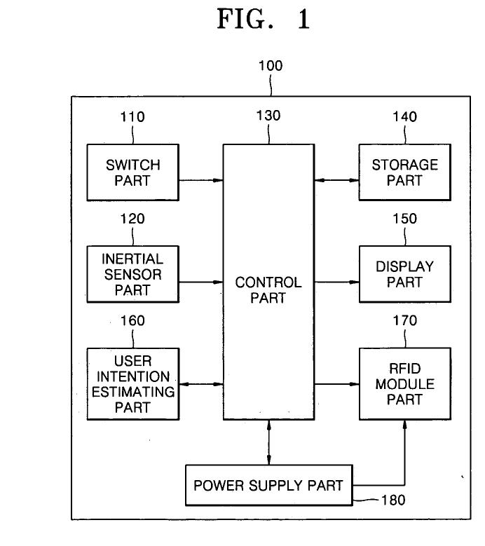

FIG. 1 is a block diagram illustrating an apparatus for controlling power of an RFID module of a handheld terminal, according to an exemplary embodiment of the present invention. The operation of the apparatus shown in FIG. 1 is controlled by a control part 130.

Referring to FIG. 1, a handheld terminal 100 includes: an RFID module part 170; a power supply part 180 which supplies power to the RFID module part 170 and the control part 130; an inertial sensor part 120 which detects motion of the handheld terminal 100 and generates a motion detection signal; a user intention estimating part 160 which recognizes motion patterns of the handheld terminal 100 using the motion detection signal, and outputs an RFID operation intention estimating signal when it is estimated that the user intends to use the RFID module part 170; a display part 150 which displays data so that the user can recognize the activation of the RFID module part 170; a switch part 110 which is separately provided to allow the user to directly drive the RFID module part 170; a storage part 140 storing reference data about the motion patterns of the handheld terminal 100; and a control part 130 which transfers the motion detection signal from the inertial sensor part 120 to the user intention estimating part 160, and controlling the power supply part 180 when the RFID operation intention estimating signal is inputted from the user intention estimating part 160, thereby activating the RFID module part 170.

The switch part 110 may be configured in a button type or in an on/off switch. The switch part 110 may also be configured to not activate the RFID module part 170 through the user intention estimating part 160, but directly operate the RFID module part 170 regardless of the user intention estimating part 160. Further, when an RFID operation mode activating signal is inputted from the user intention estimating part 160 and a switching on signal is inputted from the switch part 110, the control part 130 may be configured to control the power supply part 180 to activate the RFID module part 170.

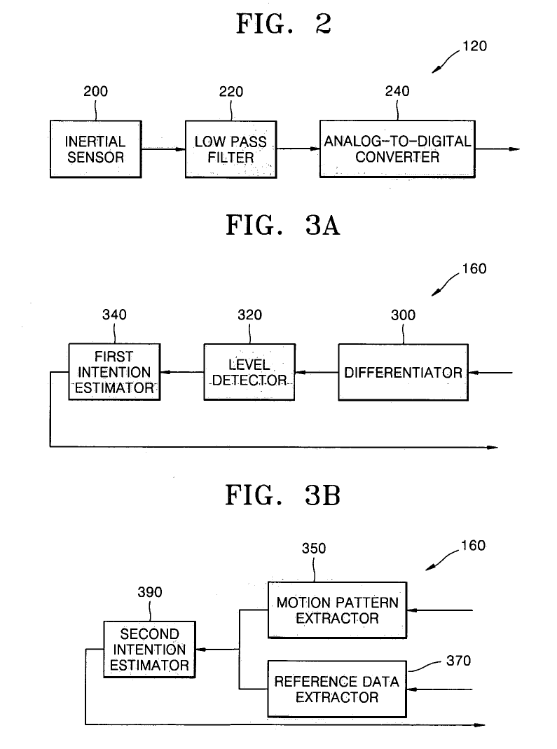

The inertial sensor part 120 detects the motion of the handheld terminal 100 and produces a motion detection signal to the control part 130. An operation of the inertial sensor part 120 will be described in detail with reference to FIG. 2.

The user intention estimating part 160 estimates whether the user intends to perform the RFID operation or not, based on the motion detection signal inputted from the inertial sensor part 120. That is, the intention to perform the RFID operation is estimated by extracting the motion pattern of the handheld terminal 100, that is moved by the user. The extraction of the motion pattern and the estimation of the user intention will be described in detail below.

In an exemplary embodiment, the power supply part 180 uses battery power to operate the variety of elements, and the RFID module part 170, which are provided inside the handheld terminal 100. However, the present invention is not limited as such, as separate battery power may be used.

In an exemplary embodiment, the storage part 140 includes a read only memory (ROM), a random access memory (RAM), and an electrically erasable and programmable ROM (EEPROM) or flash memory. The ROM stores a control program of the control part 130 and the RAM temporarily stores data that is generated during the execution of the control program. The EEPROM or flash memory stores reference data with respect to the motion pattern of the handheld terminal 100, the motion pattern being supplied to the user intention estimating part 160. The user intention with respect to the motion pattern of the handheld terminal 100 can be estimated using the reference data stored in the storage part 140.

The RFID module part 170 is a module that uses RF to transmit/receive information data from the RFID tag, which is attached to an object, and provides a related service. The RFID module is attached to the handheld terminal 100. The RFID module part 170 includes an RFID reader and an antenna. Power for the RFID module part 170 is supplied from the power supply part 180. The supply of the power may be controlled by the control part 130.

The display part 150 allows the user to recognize the operation of the RFID module part 170. For example, when the RFID module part 170 is operating, a message of “The RFID module is now operating” is displayed on a display window. The message is stored in the storage part 140 and displayed on the display part 150 under control of the control part 130. Also, various additional messages can be displayed.

The control part 130 may be implemented with a microcomputer. The control part 130 controls the power supply part 180 in response to the switching signal inputted from the switch part 110, such that the activation of the RFID module part 170 is controlled. Also, when the user intention estimating signal is inputted from the user intention estimating part 160, the control part 130 controls the power supply part 180 such that the activation of the RFID module part 170 is controlled. As described above, when the RFID operation mode activating signal is inputted from the user intention estimating part 160 and the switching on signal is inputted from the switch part 110, the control part 130 may be configured to control the power supply part 180 to activate the RFID module part 170.

FIG. 2 is a block diagram of the inertial sensor part 120 shown in FIG. 1.

Referring to FIG. 2, the inertial sensor part 120 includes an inertial sensor 200, a low pass filter 220 and an analog-to-digital converter 240.

The inertial sensor 200 senses the motion of the handheld terminal 100 and may be configured with an accelerometer and a gyroscope. A method for sensing/measuring motion of an object using the inertial sensor 200 is disclosed in Korean Patent Laid-Open Publication No. 0327602, entitled “METHOD AND APPARATUS FOR SENSING AND MEASURING THE MOVEMENTS OF THE OBJECTS IN THREE DIMENSIONS,” the disclosure of which is incorporated herein by reference.

An accelerometer is a sensor that measures an acceleration of a moving object, for example a handheld terminal 100. A pendulum of the handheld terminal 100 moves due to an acceleration. At this point, an oscillating period of the pendulum is proportional to the acceleration. Using this characteristic, the acceleration of the handheld terminal 100 can be measured by amplifying and recording the motion of the pendulum.

The gyroscope is a sensor that measures a rotational angular velocity of a moving object, for example the handheld terminal 100. The gyroscope can be classified into a mechanical gyroscope or an optical gyroscope, depending on the desired characteristics to be used in measuring the angular velocity. Examples of a gyroscope will now be described.

1. Floated Rate Integrating Gyro (FRIG)

A FRIG has the most precise performance among the available gyroscopes. However, the FRIG has a small operation range so that it is used only in a gimbaled inertial navigation system (INS). Also, it is difficult to manufacture a FRIG.

In a FRIG a pendulum driven by a hysteresis motor is installed in a gimbal. The gimbal is coupled to a case through an ultraprecise bearing. Friction between the bearing and a rotor rotating at 20,000 rpm is lowered through a floating device. The rotor and the driving motor are sealed by a cover acting as a gimbal filled with inert gas such as helium. An output-axis bearing, a damper, an angle detector and a torquer are coupled to the cover.

The angle detector measures a tilt angle of the gimbal with respect to the case and outputs an AC output.

2. Dynamically Tuned Gyro (DTG)

A DTG is a two-degree-of-freedom gyroscope that is configured by the universal coupling of a rotational shaft, a gimbal and a rotor. The DTG can measure rotations about two axes using only one gyro. A theoretic basis of the DTG was established in the 1960's and the DTG has been developed in earnest in the 1970's according to a demand for a small-sized, lightweight, low-price and precise gyro. The performance of the DTG has been continuously improved and the DTG has been widely used in a Strapdown inertial navigation system together with RLG after the 1980's.

Contrary to a general mechanical gyro, a massive rotor is disposed in an outside position and a gimbal for suspending the massive rotor is disposed in an inside position. External motion is separated using a suspension system containing two pairs of elastic elements and a gimbal. The rotor is suspended by a universal-connected suspension and rotated together with a rotating axis. The rotor and the gimbal have an angular momentum determined by a rotation speed of a motor and their inertia. Accordingly, the rotor receives a force of a spring effect from the elastic elements and also receives a force of a negative spring effect due to the mechanical effect of the rotating rotor and gimbal. A magnitude of this effect is proportional to square of the rotation speed of the rotor.

Therefore, as the rotation speed of the rotor increases, a negative spring coefficient increases and finally becomes equal to an original elastic coefficient, so that a spring coupling ratio between the rotor and the rotating axis becomes zero. This state is called a resonant state and a corresponding frequency is called a resonant frequency.

3. Fiber Optic Gyro (FOG)

A FOG is one kind of optical laser gyro that began development in the mid-1970's. The FOG obtains an angular velocity by measuring a phase difference due to interference by using an optical transport medium.

The optical gyro uses a property of light, called the Sagnac effect. According to this effect, assuming that a light source rotates at a predetermined angular velocity, when two light beams travel a closed path, having a predetermined radius in an opposite direction, the light traveling in the opposite direction of the rotation reaches a point faster than the light traveling in the direction of the rotation.

The light from the light source is split by a beam splitter and transferred to both sides of an optical fiber. Then, the light passes through the optical fiber and returns to the beam splitter. At this time, the returned light has a phase difference due to the Sagnac effect caused by the input of the angular velocity, resulting in interference patterns at a detector.

4. Ring Laser Gyro (RLG)

A RLG is a variation integral inertial sensor that detects an angular rotation amount by measuring frequency differences occurring when two laser beams with the same frequency are discharged from a gas discharge tube by using mixture of He and Ne and travel the same path around a ring in opposite directions. The ring is generally triangular or rectangular.

Since an optical energy is held within the ring by a precise mirror, reflectivity and scattering of the mirror has an important influence on the performance of the gyro.

Because the RLG is lightweight and has no rotating element, the RLG does not require a cooling system and can measure acceleration with the high degree of accuracy. For these reasons, the RLG has been widely used since the late 1980's.

5. Micro Gyro

A micro gyro is a gyro having a size of about 1 mm². The micro gyro is scaled down from a typical large sensor, using semiconductor fabrication technology, which has been recently developed. Although the micro gyro has relatively poor performance, the micro gyro can be mass-produced by semiconductor processes and a manufacturing cost is low. Thus, the micro gyro is widely used to improve performance of general industrial products, such as munitions, car navigations systems, camcorders, robots, and so on.

The micro gyro is provided by configuring a typical vibrating gyro in a planar manner while matching with semiconductor processes. Accordingly, the micro gyro uses a vibrating element, not a rotating element, so as to obtain the torque necessary for angular information from the Coriolis effect.

Since the micro gyro has no rotating part, it is highly resistant to external impact and its lifetime is semipermanent.

The low pass filter 220 of FIG. 2 removes an RF noise component from an inertial sensor signal inputted from the inertial sensor 220.

The inertial sensor signal whose RF noise component is removed by the low pass filter 220 is converted into the motion detection signal as a digital signal by the analog-to-digital converter 240. The motion detection signal is outputted to the control part 130.

FIG. 3A is a block diagram of the user intention estimating part shown in FIG. 1 according to an exemplary embodiment of the present invention.

Referring to FIG. 3A, the user intention estimating part 160 includes a differentiator 300, a level detector 320, and a first intention estimator 340. The differentiator 300 removes a DC component of the motion detection signal inputted from the inertial sensor part 120. The level detector 320 outputs a level detection signal when an output signal of the differentiator 300 has a level higher than a reference value. The first intention estimator 340 outputs an RFID operation intention estimating signal to the control part 130 when the level detection signal is inputted from the level detector 320 for a predetermined time.

The differentiator 300 differentiates the motion detection signal, thereby removing a DC component from the motion detection signal.

The level detector 320 outputs a high level signal when an output signal of the differentiator 300 has a level higher than the reference value, and outputs a low level signal when the output signal of the differentiator 300 has a level lower than the reference value.

If the first intention estimator 340 receives the high level signal from the level detector 320 for more than a predetermined time, the first intention estimator 340 estimates that the motion of the handheld terminal 100 is a motion for activating the operation of the RFID module part 170, and thus outputs the RFID operation intention estimating signal to the control part 130. Thus, the case where the high level signal is continuously inputted for more than a predetermined duration is a case where the handheld terminal 100 moves for a predetermined time and then stops.

FIG. 3B is a block diagram of the user intention estimating part according to another exemplary embodiment of the present invention.

Referring to FIG. 3B, the user intention estimating part 160 includes a motion pattern extractor 350, a reference data extractor 370, and a second intention estimator 390. It is noted that the second intention estimator 390 has been identified as “second” only to differentiate between FIGS. 3A and 3B, and is not meant to indicate only a supplemental or additional intention estimator. In this embodiment, the motion pattern extractor 350 receives the motion detection signal from the inertial sensor part 120 and extracts the motion pattern of the handheld terminal 100. The reference data extractor 370 loads a reference data signal stored in the storage part 140. The second intention estimator 390 estimates the user intention by comparing the motion pattern signal and the reference data signal, and outputs the RFID operation intention estimating signal to the control part 130 when it is determined that the user intention is to operate the RFID module part 170.

That is, the second intention estimator 390 compares the motion pattern of the handheld terminal 100, which is extracted by the motion pattern extractor 350, with the reference data for the motion pattern, which is stored in the storage part 140. Then, when it is determined that the motion pattern of the handheld terminal 100 is an operation for using the RFID module part 170, the second intention estimator 390 outputs the RFID operation intention estimating signal to the control part 130.

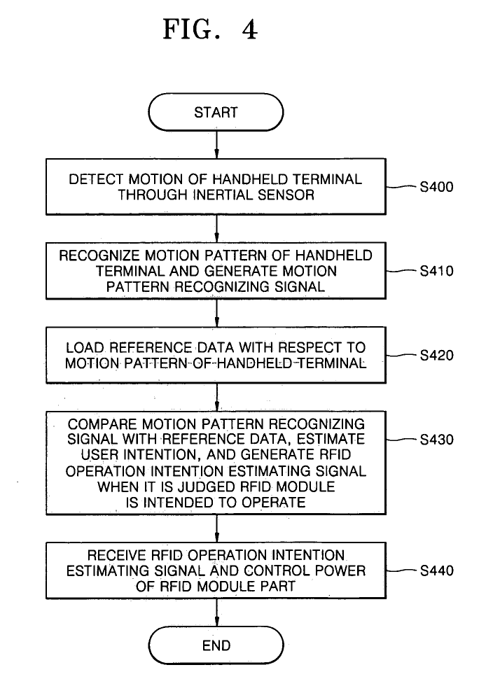

FIG. 4 is a flowchart illustrating a method for controlling a power of an RFID module of the handheld terminal according to an exemplary embodiment of the present invention.

Referring to FIG. 4, the inertial sensor part 120 detects the motion of the handheld terminal 100 and outputs the motion detection signal (S400).

The motion pattern of the handheld terminal 100 is recognized using the motion detection signal and the motion pattern recognizing signal is generated (S410).

The reference data signal with respect to the motion pattern of the handheld terminal 100 is loaded from the storage part 140 (S420).

The user intention is estimated by comparing the motion pattern recognizing signal with the reference data. When it is determined that the user intention is to operate the RFID module part 170, the RFID operation intention estimating signal is outputted to the control part 130 (S430).

When the control part 130 receives the RFID operation intention estimating signal in operation S430, the control part 130 controls the power supply part 180 that supplies power to the RFID module part 170, such that the RFID module part 170 is activated (S440). The parts that are described in FIG. 4 refer to FIGS. 1 through 3.

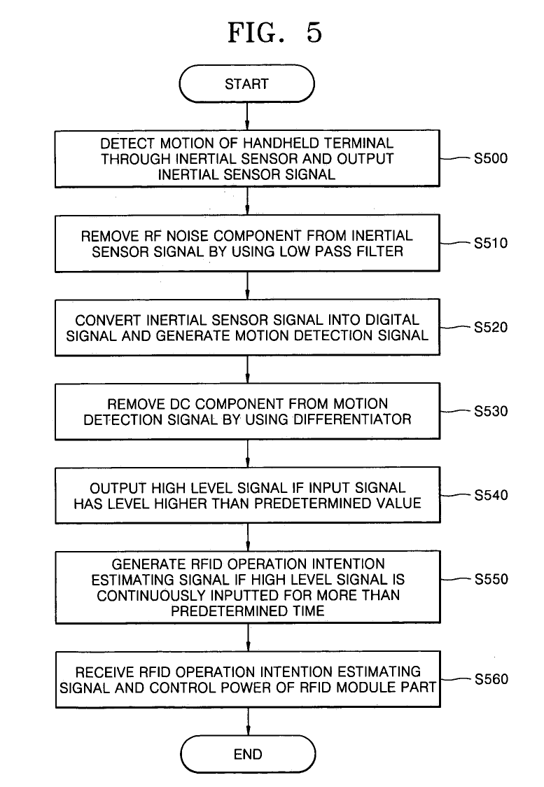

FIG. 5 is a flowchart illustrating a method for controlling a power of the RFID module of the handheld terminal according to another exemplary embodiment of the present invention.

Referring to FIG. 5, the inertial sensor 200 detects the motion of the handheld terminal 100 and outputs the inertial sensor signal (S500).

The inertial sensor signal passes through the low pass filter 220 such that the RF noise component is removed (S510).

The inertial sensor signal, RF noise component of which is removed, is converted into a digital signal and the motion detection signal is outputted to the user intention estimating part 160 (S520).

The motion detection signal inputted in operation S520 is differentiated by the differentiator 300, such that the DC component is removed (S530).

The level detector 320 outputs a high level signal when the output signal of the differentiator 300 has a level higher than a reference value, and outputs a low level signal when the output signal of the differentiator 300 has a level lower than the reference value (S540).

It is then determined whether the high level signal is continuously inputted for more than a predetermined time (S550). If the high level signal is continuously inputted for more than a predetermined time, it is estimated that the motion of the handheld terminal 100 is a motion for activating the operation of the RFID module part 170, and the RFID operation intention estimating signal is outputted to the control part 130. Thus, the case where the high level signal is continuously inputted for more than a predetermined duration is a case where the handheld terminal 100 moves for a predetermined time and then stops.

The control part 130 receives the RFID operation intention estimating signal in operation S550, the control part 130 controls the power supply part 180 that supplies power to the RFID module part 170, such that the RFID module part 170 is activated (S560). The parts that are described in FIG. 5 refer to FIGS. 1 through 3.

According to the present invention, the power consumption of the handheld terminal 100 having the RFID module can be reduced. Therefore, when the RFID module is mounted on the handheld terminal, the power consumption is reduced so that the handheld terminal can be used for a long time.

Also, the user can directly control the RFID module through the switch part 110. Thus, the utility of the handheld terminal having the RFID module can be improved.

The invention can also be embodied as computer-readable codes on a computer-readable recording medium. The computer-readable recording medium is any data storage device that can store data which can be thereafter read by a computer system. Examples of the computer-readable recording medium includes read only memory (ROM), random access memory (RAM), CD-ROMs, magnetic tapes, floppy disks, optical data storage devices, and carrier waves (such as data transmission through the Internet). The computer-readable recording medium can also be distributed over network coupled computer systems so that the computer-readable code is stored and executed in a distribution fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for controlling a power of a radio frequency identification (RFID) ( ) module mounted on a device, the apparatus comprising:
a power supply part which supplies power to the RFID module;
an inertial sensor part which detects a motion of the device and outputs a motion detection signal;
a user intention estimating part which recognizes a motion pattern of the handheld terminal using the motion detection signal, and outputs an RFID operation intention estimating signal based on the motion pattern; and
a control part which activates the power supply part if the RFID operation intention estimating signal is input into the control part.

2. The apparatus of claim 1, wherein the user intention estimating part estimates that a user intends to use the RFID module based on the motion pattern.

3. The apparatus of claim 1, wherein the user intention estimating part includes:
a differentiator which removes a DC component from the motion detection signal;
a level detector which outputs a level detection signal if an output signal of the differentiator has a level higher than a reference value; and
an intention estimator which outputs the RFID operation intention estimating signal to the control part if the level detection signal is input from the level detector for a predetermined duration.

4. The apparatus of claim 1, further comprising a storage part which stores reference data with respect to the motion pattern of the device, wherein the user intention estimating part estimates a user intention by extracting motion pattern data from the motion detection signal, which is input from the inertial sensor part, and compares the motion pattern data with the reference data, which is stored in the storage part.

5. The apparatus of claim 1, wherein the inertial sensor part comprises:
an inertial sensor which senses a variation in the motion of the device; and
an analog-to-digital converter which converts an output signal of the inertial sensor into a digital signal and outputs the motion detection signal.

6. The apparatus of claim 5, wherein the inertial sensor comprises an accelerator.

7. The apparatus of claim 5, wherein the inertial sensor comprises a gyroscope.

8. The apparatus of claim 7, wherein the gyroscope comprises one of a floated rate integrating gyro, a dynamically tuned gyro, a fiber optic gyro, a ring laser gyro and a micro gyro.

9. The apparatus of claim 1, further comprising a display part which allows a user to recognize the operation of the RFID module.

10. The apparatus of claim 1, further comprising a switch part which drives the RFID module, wherein if a switching on signal is input from the switch part, the control part controls the power supply part to operate even if the RFID operation intention estimating signal is not input.

11. The apparatus of claim 1, further comprising a switch part which drives the RFID module, wherein if a switching on signal is inputted from the switch part and the RFID operation intention estimating signal is input into the control part the control part controls the power supply part to operate.

12. A method for controlling power of a radio frequency identification (RFID) module mounted on a device, the method comprising:
detecting a motion of the device using an inertial sensor and outputting a motion detection signal;
recognizing a motion pattern of the device using the motion detection signal, estimating a user intention, and outputting an RFID operation intention estimating signal; and
if the RFID operation intention estimating signal is input, controlling a power supply part to activate the RFID module.

13. The method of claim 12, wherein the recognizing the motion pattern, the estimating the user intention and the outputting the RFID operation intention estimating signal comprises:
recognizing the motion pattern of the device and outputting a motion pattern recognizing signal;
loading reference data with respect to the motion pattern of the device, wherein the reference data is stored in a storage part; and
comparing the motion pattern recognizing signal with the reference data and estimating a user intention.

14. The method of claim 12, wherein the recognizing the motion pattern, the estimating the user intention and the outputting the RFID operation intention estimating signal comprises:
passing the motion detection signal through a differentiator to remove a DC component from the motion detection signal;
outputting a level detection signal if an output signal of the differentiator has a level higher than a reference value; and
outputting the RFID operation intention estimating signal if the level detection signal is continuously input from the level detector for a predetermined duration.

15. The method of claim 12, wherein the outputting the motion detection signal comprises:
detecting the motion of the device through an inertial sensor and outputting an inertial sensor signal;
removing an RF noise component from the inertial sensor signal by passing the inertial sensor signal through a low pass filter; and
converting the inertial sensor signal into a digital signal and outputting the motion detection signal.

16. The method of claim 15, wherein the inertial sensor comprises at least one of an accelerator and a gyroscope.

17. A computer-readable recording medium storing a program for executing a method for controlling power of a radio frequency identification (RFID) module mounted on a device, the method comprising:
detecting a motion of the device using an inertial sensor and outputting a motion detection signal;
recognizing a motion pattern of the device using the motion detection signal, estimating a user intention, and outputting an RFID operation intention estimating signal; and
if the RFID operation intention estimating signal is input, controlling a power supply part to activate the RFID module.
